(19) United States
(12) Patent Application Publication
(10) Pub. No.: US 2012/0092357 A1
(43) Pub. Date: Apr. 19, 2012

(54) Region-Based Image Manipulation

(75) Inventors: Jingdong Wang, Beijing (CN); Xian-Sheng Hua, Beijing (CN)

(73) Assignee: Microsoft Corporation, Redmond, WA (US)

(21) Appl. No.: 12/904,379

(22) Filed: Oct. 14, 2010

(51) Int. Cl. G09G 5/00

(52) U.S. Cl. 345/581; 345/619

(57) ABSTRACT

Region-based image manipulation can include selecting and segmenting regions of a particular image. The regions are identified through the use of simplified brushstrokes over pixels of the regions. Identified regions can be manipulated or transformed accordingly. Certain implementations include filling in regions with other images or objects, and include performing a text query to search for such images or objects.

### BACKGROUND

With the ever-increasing use of digital media and prevalence of digital images, there becomes an increasing need for effective and efficient editing tools to manipulate digital images. Editing and manipulating digital images includes altering objects and regions of images. In certain situations, users desire to replace objects and regions of images.

Typical image editing and manipulating can involve tedious manual selection of an object and region in an image. For example, a user may have to precisely use a pointing and selection device, such as a mouse, to choose the object or region of interest. This technique can be time consuming and frustrating to a user.

In certain cases, a user desires to replace a region, such as a selected background, of the image with a different region (e.g. background); however, the options for the user may be limited. In other words, certain image editing and manipulating methods provide limited or no access to other regions to replace the selected region or background of the image.

Oftentimes when an object or region of an image is transformed, such as increasing or decreasing the size of the object or region, the transformed object or region may have disproportionate pixels compared the rest of the image. For example, when an object or region is transformed, the pixels of the object or region can be different and can affect consistent coloring and granularity of the image. Typically, an extra user process is involved in correcting the pixels.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations herein provide techniques for image manipulation by selecting and manipulating region levels of images. In certain implementations, searching is performed of other regions or objects to replace a selected region.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a block diagram of a framework for region-based image manipulation according to some implementations.

FIG. 2 depicts an example of an image for region-based image manipulation according to some implementations.

FIG. 3 depicts an example of an image to be manipulated that a user marks with brushstrokes to identify regions according to some implementations.

FIG. 4 is a diagram an example tree structure and an augmented tree structure according to some implementations.

FIG. 5 is a block diagram for a process to interactively select or segment an image according to some implementations.

FIG. 6 is a block diagram for a process for coherence matting according to some implementations.

FIG. 7 is graph diagram of a feathering function according to some implementations.

FIG. 8 depicts an example of image that includes a bounding box of a selected region according to some implementations.

FIG. 9 is a block diagram of images for image region translation according to some implementations.

FIG. 10 is a block diagram of images for image region enlargement according to some implementations.

FIG. 11 is a block diagram of images for image region rotation enlargement according to some implementations.

FIG. 12 is a notation diagram of an image according to some implementations.

FIG. 13 is a block diagram of an example system for carrying out region-based image manipulation according to some implementations.

FIG. 14 is a block diagram of an example server computing device region for based image manipulation according to some implementations.

FIG. 15 is a block diagram of an example client computing device for region-based image manipulation according to some implementations.

FIG. 16 is a flow diagram of an example process for region-basedregion-based image manipulation according to some implementations.

### DETAILED DESCRIPTION

### Region Level Manipulating

The techniques described herein are generally directed towards techniques for selecting and manipulating (i.e., editing) of images. Some implementations employ selecting and manipulating images at a region or object level. This can be performed using simplified strokes over a desired region or object, and selecting the region or object. The selected object or region is separated from the remainder of the image, and can be manipulated as desired.

A user can be given the option to replace the selected area or “blank” region of the image, with another region, using a query, such as a text query. The query can be performed on one or more image databases that include relevant regions that can replace the selected region. The replacement region seamlessly replaces the selected or blank region of the image to create a new image.

The selected region or object may be manipulated by moving a pointing device, such as a mouse, over the selected region or object. Manipulation of the region or object can include translation, rotation, deletion, and re-coloring.

After the region or object is manipulated or transformed, placement of the region or object can be automatically performed without the user intervention. Region placement is a process of composing the transformed region or image with the completed image. This can also include automatically transforming the pixels of the selected region or object with user intervention.

### Example Framework for Region-Based Image Manipulation

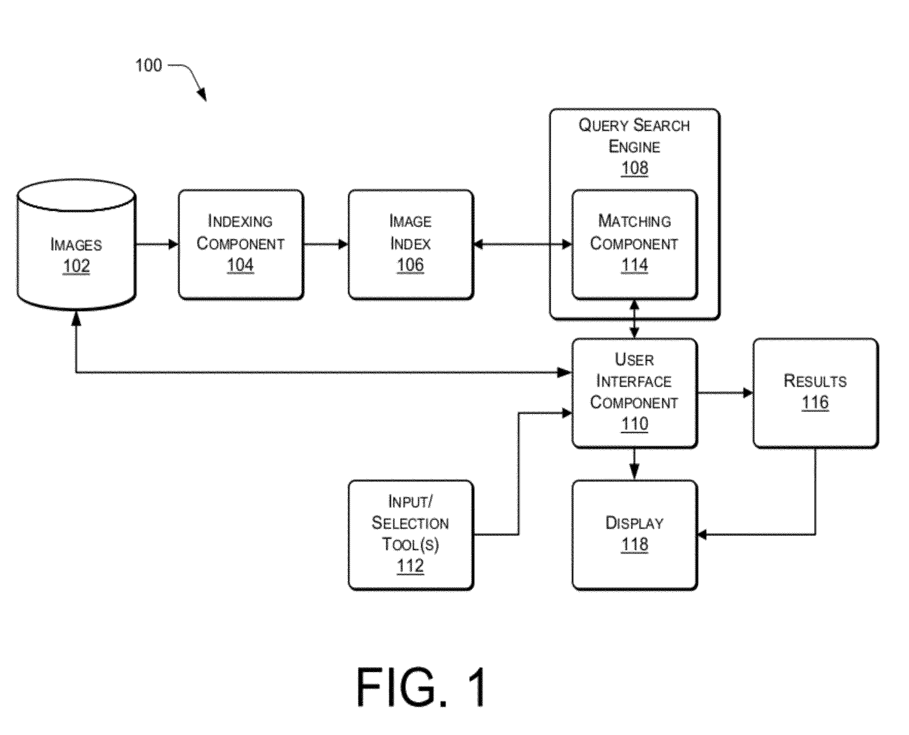

FIG. 1 is a block diagram of an example of an interactive region-based image manipulation framework 100 according to some implementations herein. The framework 100 is capable of performing as a real-time region-based image manipulation system for editing and searching a multitude of images. The framework 100 may be part of, or included in, a self contained system (i.e., a computing device, such as a notebook or desktop computer), or a system that includes various computing devices and peripheral devices, such as a network system. It is also contemplated, that framework 100 may be part of a much larger system that includes the Internet and various area networks. The framework 100 may enable region-based manipulation of images and query searching of one or more images in an image source, such as a database, the Internet, or the like, as represented by images 102.

For example, images 102 may be obtained from any suitable source, such as by crawling Internet websites, by downloading or uploading image databases, by storing images from imaging devices to computer storage media, and so forth. In some implementations, images 102 may be millions or even billions of images, photographs, or the like, available on the World Wide Web. The indexing stage 102 also includes an indexing component 104 for generating an image index 106 of the images 102. Image index 106 may be a text based image index for identifying one or more images based on text. In some implementations, the indexing component 104 identifies images of images 102 based on text. It is noted, that other query searches and indices can be implemented, including visual/graphical similarity of images.

The image index 106 generated may be made available for use by a query search engine 108. The query search engine 108 may provide a user interface component 110 to be able to receive a query, such as a text query. In the illustrated implementation, user interface component 110 is provided with query search engine 108.

The user interface component 110 may be presented as a webpage to a user in a web browser window. In other implementations, the user interface component 110 may be incorporated into a web browser or other application on a computer, may be an add-in or upgrade to a web browser, etc. The user interface component 110 can be configured to receive images from images 102. Input/selection tool(s) 112 which can include one or more interfaces are provided to a user to provide input to the user interface component 110. Examples of input/selection tool(s) 112 including pointing devices such as mice, keyboards, etc. Input/selection tool(s) 112 in particular, can be used to select/deselect, and manipulate images as further described below. Furthermore, the input/selection tool(s) 112 can be used to enter queries (e.g., text queries), for images or regions to replaced desired regions of images (e.g., new background regions), as also further described below.

Query search engine 108 can also include a matching component 114 configured to receive queries, and perform searching of one or more images from images 102, that correspond to a query input. In some implementations, the matching component 114 uses a query matching scheme based text indices of images. The matching component 114 identifies one or more images corresponding to a text input provided by a user through input/selection tool(s) 112.

The user interface component 110 outputs one or more of the identified images as results 116. The results 116 may be displayed on display 118 in real-time to the user. If the user is not satisfied with the results 116, the user may interactively and iteratively, modify query input through input/selection tool(s) 112, such as by adding additional text.

The display 118 shows the image to be manipulated by the user. Manipulation of the image on the display is performed by the user through input/selection tool(s) 112 interfacing through the user interface component 110.

### Opening an Image

An image to be manipulated can be selected images 102, implementing system 100 described above. In particular, the manipulated image may be called up by user interface component 110 as instructed/requested through input/selection tool(s) 112. In other implementations, the image to be manipulated can be called up or opened using other methods and implementing other sources. A menu can be provided by the user interface component and displayed on display 118. The menu provides an option to a user to open the image to be manipulated.

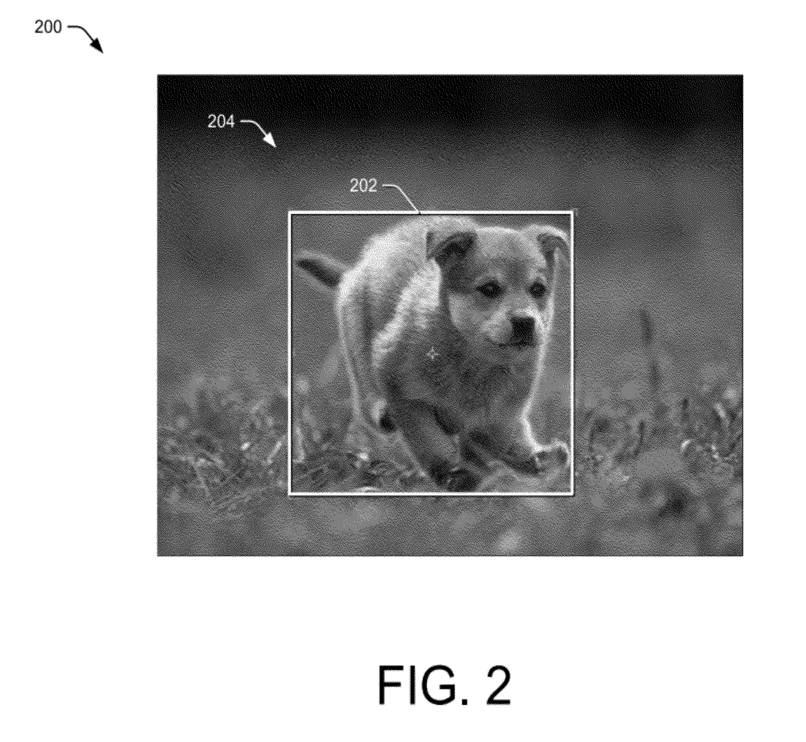

FIG. 2 illustrates an example image 200 that can be manipulated. In this example, the region of interest is 202. In particular, the region or object of interest is a “dog.” The region 204 is the background of image 200. Manipulation can be performed on region 202, and region 204 can be replaced, as discussed below.

### Image Region Selection and Segmentation

An interactive region selection and segmentation process can be implemented and provided to user to allow the user to draw a few strokes to indicate the region of interest and non-interest over particular pixels of the image. An optimization algorithm is used to segment pixels of interest from pixels of non interest.

Image segmentation is directed to cutting out areas of interest from areas from images, to decompose the image to several “blobs” for analysis. In is desirable to provide the user a simple, yet relatively quick process for image segmentation.

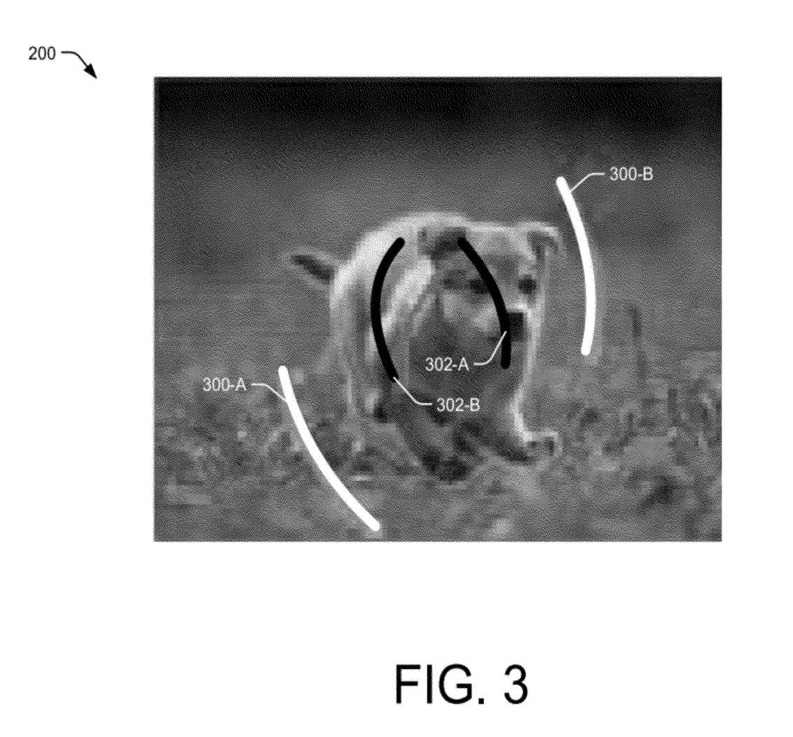

FIG. 3 illustrates the example image 200 to be manipulated. A user draws brushstrokes 300-A and 300-B to differentiate the background of the image 200. Brushstrokes 300 may be a particular color or shade. The user can draw brushstrokes 302-A and 302-B to select the object of interest in image 200. Brushstrokes 302 can be a different color or shade from brushstrokes 300, to particularly delineate region of interest from the other region of the image 200.

A graph structure can represent an image. A minimum spanning tree can be used to approximate the graph structure of the image, and an augmented tree structure can be used to incorporate label information of nodes of the tree. The augmented tree structure can be used to model the image and image segmentation can be performed based on the augmented tree structure.

A graph represented by [symbol] ={ [symbol] , E}, defines an image, and includes all pixels or super-pixels as the graph's vertices. Each pair of pixels that are spatial neighbors, has an edge connecting them. The length of the edge is computed as the distance between the pair's corresponding two vertices u and v as follows:

g(u, v)=∥fᵤ−fᵥ∥ (1)

Where fᵤ and fᵥ are the RGB values of the pixels. Because a graph can be cyclic and processing of a graph can be lengthy in time and complexity, a tree can be used to model the image. A tree structure, as represented by T=( [symbol] ,E), is an acyclic and connected graph having one root node, and each root node other than the root node has a unique parent node.

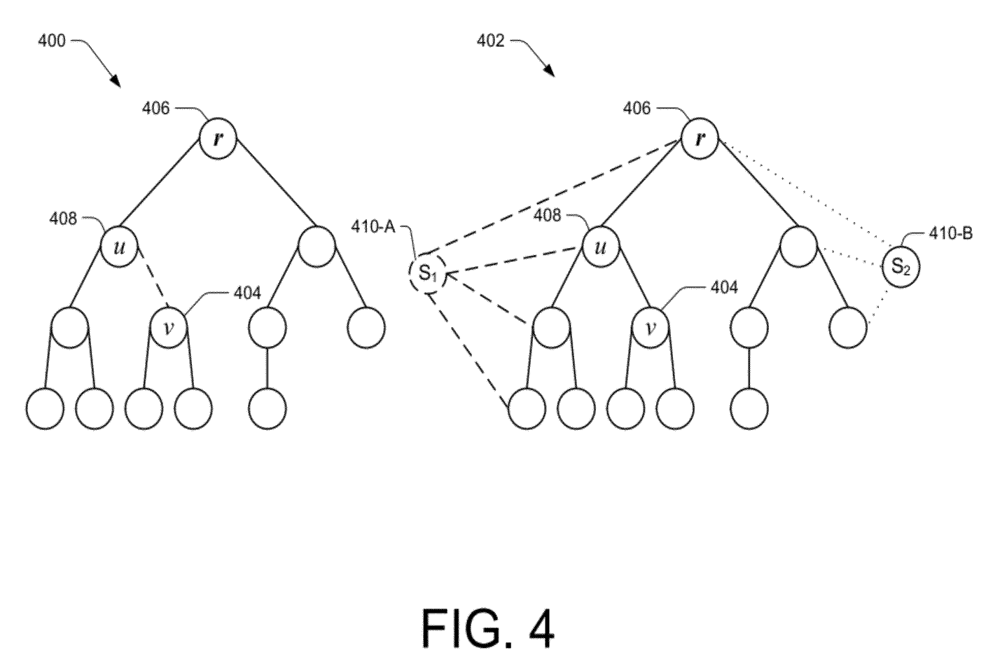

FIG. 4 shows an example tree structure 400 and an augmented tree structure 402. A minimum spanning tree criterion can be used to convert the graph to the tree. For example, as is known in the art, Prim's algorithm or Kruskal's algorithm can be implemented to efficiently perform the conversion. In tree 400, pa(v) is defined as the parent node of v 404. Tᵥ is defined as the sub tree rooted from node v 404. For example, Tᵥ is formed by node v 404 and its two child nodes. The root node or r 406, is defined as r ∈ [symbol] , and the depth of all other nodes v ∈ [symbol] can be denoted as dᵥ, and is the number of the edges of the shortest path from r 406 to v 404 (in this example the path goes through node u 408). And it follows that dᵥ=dₚₐ₍ᵥ₎+1, as seen in augmented tree structure 402. By default, the root node, r 406, has a depth of 0.

For k-way segmentation, the augmented tree structure 402 is formed by adding several abstract nodes, s₁ 410-A and s₂ 410-B, defined by {sᵢ}ᵢ₌₁^{k}. The abstract nodes 410 are connected with all nodes [symbol] in the augmented tree structure 402. Each of the abstract nodes 410 can be interpreted as indicating the k^{th} possible labels. The augmented tree structure 402 is defined as:

T′=( [symbol] ∪ {sᵢ}ᵢ₌₁^{k}, ∈ ∪ ∈ₐ) (2)

where (∈ₐ={(v,s)}), v ∈ [symbol] and s ∈ {sᵢ}ᵢ₌₁^{k}

Partitioning on the augmented tree structure can be defined as separating the nodes [symbol] into k disjoint subsets, { [symbol] ᵢ ∪ ≡5sᵢ}}ᵢ₌₁^{k}, such that [symbol] ᵢ ∩ [symbol] ⱼ=Ø, ∪ᵢ₌₁^{k} [symbol] ᵢ= [symbol] , and there are no edges between [symbol] ᵢ and [symbol] ⱼ, which can be resolved by removing some edges. To incorporate prior information provided by a user, an additional constraint may be made that augmented nodes defined as s ∈ {sᵢ}ᵢ₌₁^{k} lie in different subsets.

By denoting or labeling on the nodes [symbol] as L={lᵥ} where lᵥ is the subset that v belongs to, an optimum partition is a goal that maximizes the following probability measure equation:

P(L)=ΠᵥP(sₗ_{ᵥ},lᵥ)ΠᵥT(lᵥ|lₚₐ₍ᵥ₎) (3)

where P(sₗ_{ᵥ}, lᵥ) encodes the likelihood that node v ∈ [symbol] is connected to sₗ_{ᵥ}. In some implementations, a node may be connected to one and only one of the abstract nodes, s. In some implementations, this likelihood may be evaluated by learning a Gaussian mixture model (GMM) in the RGB color space from the labeled pixels.

T(lᵥ|lₚₐ₍ᵥ₎) encodes the likelihood of lᵥ given the label of its parent node, which represents the tree structure 400. For example, as is known in the art, the Potts model may be used as follows:

$$T ( {l}_{v} \vert {l}_{pa ( v )} ) = \frac{1}{Z} \{ \begin{matrix}1 , & {l}_{v} = {l}_{pa ( v )} \\ 1 - Exp ( - λ g ( v , pa ( v ) ) , & {l}_{v} \neq {l}_{pa ( v )}\end{matrix}$$

where g(v, pa(v)) is the distance measure of v and pa(v) is defined above. Z is a normalization parameter, and λ controls the steepness of the exponential function. For example, λ can be set to 1 by default.

An efficient dynamic procedure can be adopted to maximize Eqn. (3) above, as described by the following. Sub tree Tᵥ is rooted from node v. The function qᵥ(lᵥ) is defined with label lᵥ of the node v label by the following equation:

qᵥ(lᵥ)=max_{l*p}(lᵥ,l* ) (5)

where l* represents the possible labels of all the nodes in sub tree Tᵥ except node v; and p(lᵥ,l*)=P_{T}_{ᵥ}(L_{T}_{ᵥ}) is the probability measure in sub tree Tᵥ. For the internal nodes of the tree, from the Markov and acyclic properties, the following recursive calculation is followed:

$$\begin{matrix}{q}_{v} ( {l}_{v} ) = {max}_{\{ {l}_{w} , w ∈ {C}_{w} \}} P ( {s}_{{l}_{v}} , {l}_{v} ) {\prod }_{w ∈ {C}_{v}} T ( {l}_{w} \vert {l}_{v} ) {q}_{w} ( {l}_{w} ) \\ = P ( {s}_{{l}_{v}} , {l}_{v} ) {\prod }_{w ∈ {C}_{v}} {max T ( {l}_{w} \vert {l}_{v} ) {q}_{w} ( {l}_{w} )}_{{l}_{w}}\end{matrix} \qquad ( 6 )$$

It follows that for leaf v, qᵥ(lᵥ) can be evaluated directly as qᵥ(lᵥ)=p(lᵥ)=P(sₗ_{ᵥ}, lᵥ). Therefore, qᵥ(lᵥ) for all the internal nodes and the root node can be evaluated in a recursive bottom-up way. If the maximum depth of the tree is D, the nodes with depth D are leaves, and their posterior probabilities qᵥ(lᵥ) can be directly evaluated as discussed above. The function qᵥ(lᵥ) may be evaluated for all the nodes with depth D −1 using Eqn. (6). Similarly, the process is repeated in a decreasing depth order until the root node is reached.

Optimal labeling can be then found in a top-down way from the root node to leaf nodes. The optimal label assignment for root node r can be written as l*ᵣ=arg maxₗ_{ᵣ}qᵣ (lᵣ). The optimal value at root node r is used to find the labels of its children ω ∈ Cᵣ by replacing max with arg max in Eqn. (6). The value of arg max can be recorded in the process of bottom-up posterior probability evaluation. Then the process can follow by going down the tree in order of increasing depth to compute the optimal label assignment of each child node ω, by using the pre-computed arg maxₗ_{_{ω}}.

In summary, two passes are performed on the tree: the bottom-up pass evaluates the posterior probabilities in a depth decreasing order starting from the leaf nodes, and the top-down pass assigns the optimal labels in a depth increasing order starting from the root node.

### Use of Superpixels

In certain cases, in order to make tree partitioning more practical, a graph coarsening step can be performed before tree fitting. In particular, the image graph can be coarsened by building the graph on the superpixels of the image. This can provide at least two advantages: 1) the memory complexity of the graph is reduced, and 2) the time complexities of tree construction and inference on the tree are reduced. The distance g between two superpixels C₁ and C₂ is defined and based on external and external differences by the following equation:

g(C₁, C₂)=max (d(C₁, C₂)/Int(C₁), d(C₁, C₂)/Int(C₂)) (7)

the external difference d is defined to be the minimum distance among spatial neighboring pixels as defined by the following equation:

d(C₁, C₂)=min_{u∈c}_{_{1,}}_{v∈c}_{_{2,}}_{(u,v)∈ε}g(u, v) (8)

and the internal difference Int(C) is defined as:

Int(C)=max_{(u,v)∈MST(C)}g(u,v) (9)

where the maximization is done over the edges in the minimum spanning tree MST(C) of the superpixel C.

### Image Segmentation Using Algorithms

Using the algorithms and methods described above, image segmentation can be performed. Results based on tree portioning are obtained by segmenting the superpixels as described above. The graph structure can be constructed by setting the superpixels as the nodes and connecting two superpixels, if the superpixels are spatial neighbors. A minimum spanning tree is constructed to approximate the graph.

Now referring back to FIG. 3, in the example image 200, for interactive image segmentation, a user draws several scribbles as represented by brushstrokes 300 and 302. The brushstrokes 300 and 302 mask the pixels of the images as different objects, and in particular an object or region of interest and a separate and distinct background of the image. The masked pixels of brushstrokes 300 and 302 are set has hard constraints. To impose setting the pixels as hard constraints, the following conditions are set: P(iᵥ|lᵥ)=0, if lᵥ is not as label as indicated by the user, otherwise P(iᵥ|lᵥ)=1.

### Image Segmentation Using Algorithms

Using the algorithms and methods described above, image segmentation can be performed. Results based on tree portioning are obtained by segmenting the superpixels as described above. A graph structure can be constructed by setting the superpixels as the nodes and connecting two superpixels, if the superpixels are spatial neighbors. A minimum spanning tree is constructed to approximate the graph structure.

### Interactive Region Selection

As discussed above, processes and techniques are described to provide a user with the ability to interactively select a region (e.g., region 202) of an image (e.g., image 200). The user can draw a few strokes to indicate the region of interest and region of non-interest over those pixels under the strokes. Then an optimization algorithm is used to propagate the region of interest and region of non-interest.

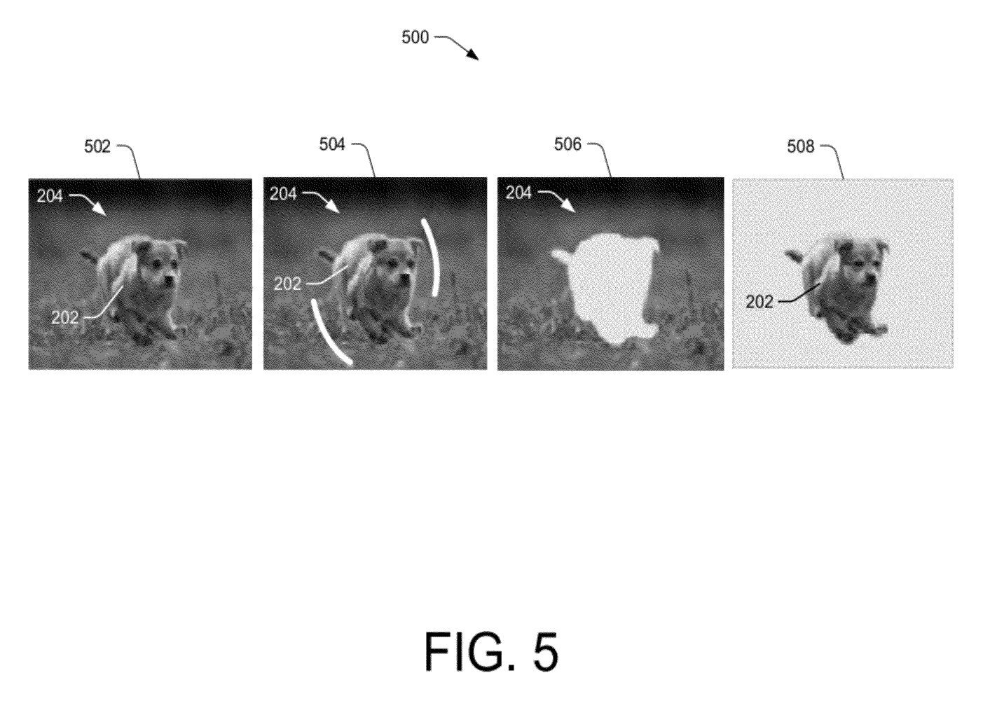

FIG. 5 shows a process 500 to interactively select or segment an image. In this example, the image 200 of FIG. 2 is referred illustrated. At image 502, the original image is illustrated, with a foreground or region of interest 202, and a background or region of non interest 204. At image 504, as discussed above in reference to FIG. 3, brushstrokes can be provided by the user to indicate the regions of interest 202 and non interest 204. At image 506, the region of non interest or background 204 is illustrated. At image 508, the region of interest or foreground 202 is illustrated. After a user selects the regions, i.e., foreground or region of interest 202 and background or region of non interest 204, the following described processes can be performed without user intervention. It will also be apparent, that the above described processes and techniques can also be performed intervention.

### Region Boundary Refinement

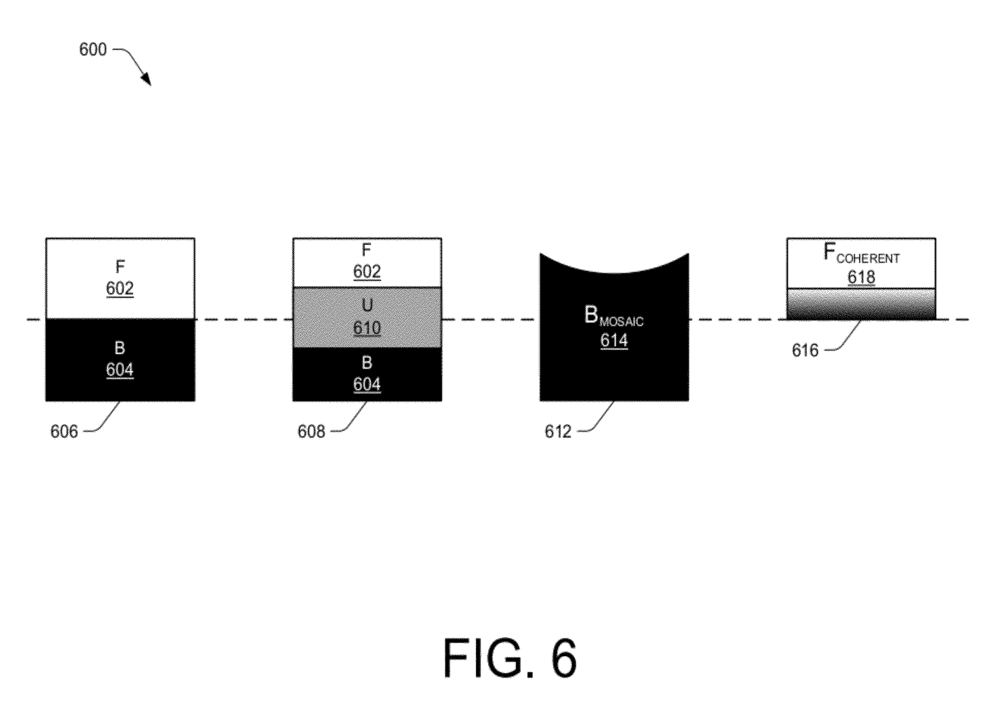

To determine uncertain regions along a boundary, the following techniques can be implemented. FIG. 6 shows a process 600 for coherence matting. A user specifies an approximate region segmentation as represented by a foreground or F 602, which can be representative of a desired region of the image. A background region or B 604 is identified in block 606. At the block 608, an uncertain region U 610 is added between F 602 and B 604. Next at block 612, a background mosaic or B_{MOSIAC} 614 can be const multiple under-segmented background images. At block 616 coherent foreground layer is then constructed using coherence matting.

By incorporating a coherence prior on an alpha channel L(α), coherence matting can be formulated using the following equation:

L(F, B, α|C)=L(C|F, B, α)+L(F)+L(α) (10)

the log likelihood for the alpha channel L(α) can be modeled as:

L(α)=−(α−α₀)²/σ_{α}² (11)

where α₀=f(d) is a feathering function of d and σ_{α}² is the standard deviation. The variable d is the distance from the pixel to the layer boundary. The feathering function f(d) defines the a value for surrounding pixels of a boundary.

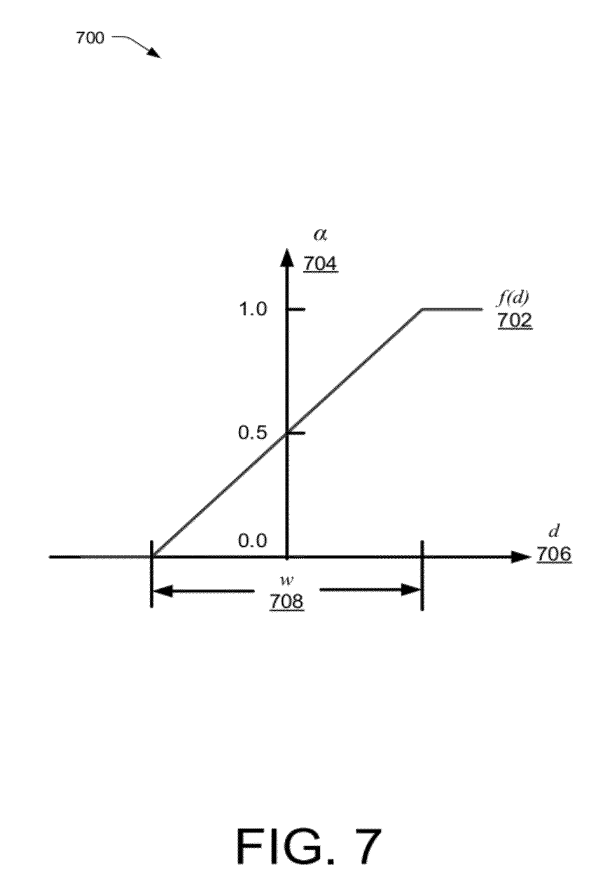

FIG. 7 shows a graph 700 of an example of a feathering function f(d) 702, where α 704 is plotted against d 706. For example, the feathering function f(d) 702 can be set as f(d)=(d/w)*0.5+0.5, where w 708 is feathering width, as illustrated in FIG. 7.

It can be assumed that observed color distribution P(C); and sampled foreground color distribution P(F), from a set of neighboring foreground pixels, are of Gaussian distribution as defined by the following equations:

L(C|F, B, α)=−∥C−αF−(1−α)B∥²/σ_{C}² (12)

L(F)=−(F− F̅)^{T} Σ_{F}⁻¹(F− F̅) (13)

where σ_{C} is the standard deviation of the observed color C, F̅ is the weighted average of foreground pixels and Σ_{F} is the weighted covariance matrix. Taking the partial derivatives of equation (10) with respect to F and α and setting them to equal zero, results in the following equations:

$$\begin{matrix}F = \frac{{\sum }_{F}^{- 1} \overline{F} + C α / {σ}_{C}^{2} - B α ( 1 - α ) / {σ}_{C}^{2}}{{\sum }_{F}^{- 1} + I {α}^{2} / {σ}_{C}^{2}} & ( 14 ) \\ α = \frac{( C - B ) \cdot ( F - B ) + {α}_{0} \cdot {σ}_{C}^{2} / {σ}_{a}^{2}}{{‖ F - B ‖}^{2} + {σ}_{C}^{2} / {σ}_{a}^{2}} & ( 15 )\end{matrix}$$

Values for α and F are solved alternatively by using (14) and (15). Initially, α can be set to α₀.

### Region Image Representation

Referring back to FIG. 2, in certain cases, the selected image region 202 can be represented by a 32-bit Bitmap image and a bounding box. For a 32-bit Bitmap image, four channels R, G, B, A can be used for each pixels, where R represents red color value, G represents green color value, B represents blue color value, and A represents the alpha value or a. For example, as is known in the art, the alpha value or a indicates the transparency can be obtained the boundary refinement process described below.

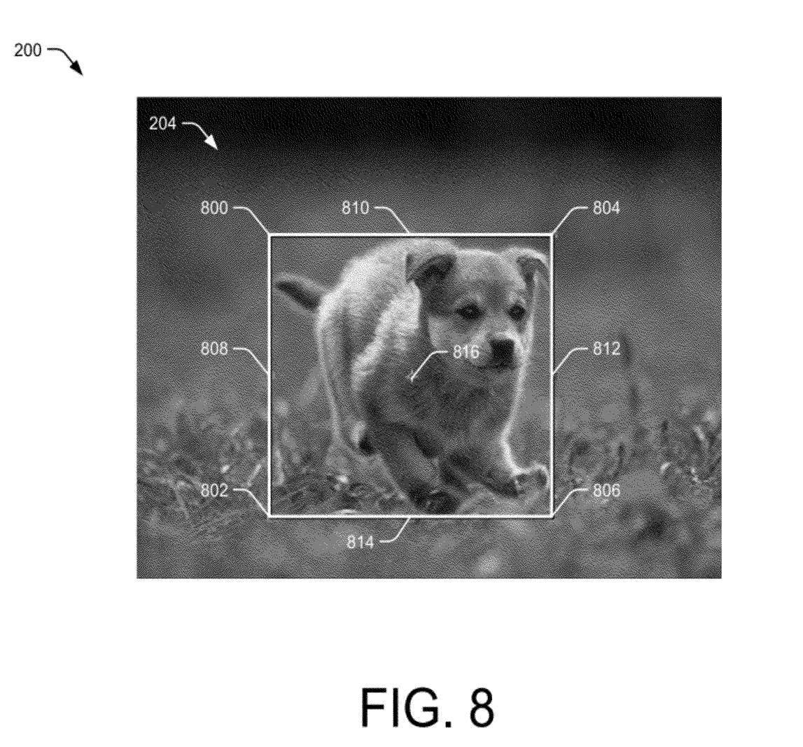

FIG. 8 shows a bounding box of selected region 202 of image 200. For selected regions, a bounding box may be created. The bounding box can be represented by particular coordinates, and defined, for example, by eight points. The following can defined particular axis coordinates of the boundary box: “x_l” represents the x-coordinate of the most left pixel of the selected image region, “x_r” is the x-coordinate of the most right pixel in the selected image region, “y_t” is the y-coordinate of the most top pixel in the selected image region, and “y_b is the y-coordinate of the most bottom pixel in the selected image region. Therefore in this example of FIG. 8, the point 800 is represented by (x_l, y_t), the point 802 is represented by (x_l, y_b), the point 804 is represented by (x_r, y_t), and the point 806 is represented by (x_r, y_b). The four other points of the boundary box can include points 808, 810, 812, and 814. Therefore, in this example, eight points are selected from the bounding box, which include four corner points and four middle points of each edge of the bounding box.

### Image Transformation Operations

The bounding box described above in reference to FIG. 8 can be used to transform a selected or segmented region. The four corner vertices or points, points 800, 802, 804, and 806 of the bounding box can be used to scale up/down the selected region while keeping an aspect ratio of the region. The four points in the middle of the four edges, points 808, 810, 812, and 814 can be used to scale the selected region along a particular direction. An interior middle point 816 can be used to rotate the selected region.

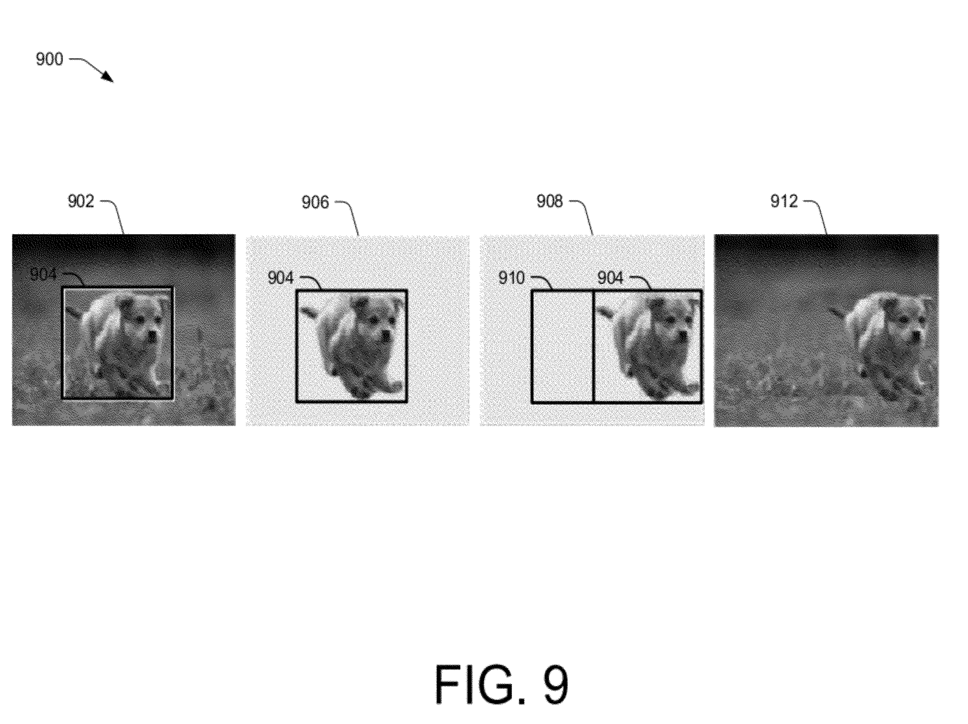

FIG. 9 shows a process 900 for image region translation. Image 902 is an original image that includes a selected image region 904 having a boundary box as selected by a user. Image 906 shows the selected image region 904. Image 908 shows translation of the selected image region 904 from an original position 910. Image 912 shows the resulting composited image.

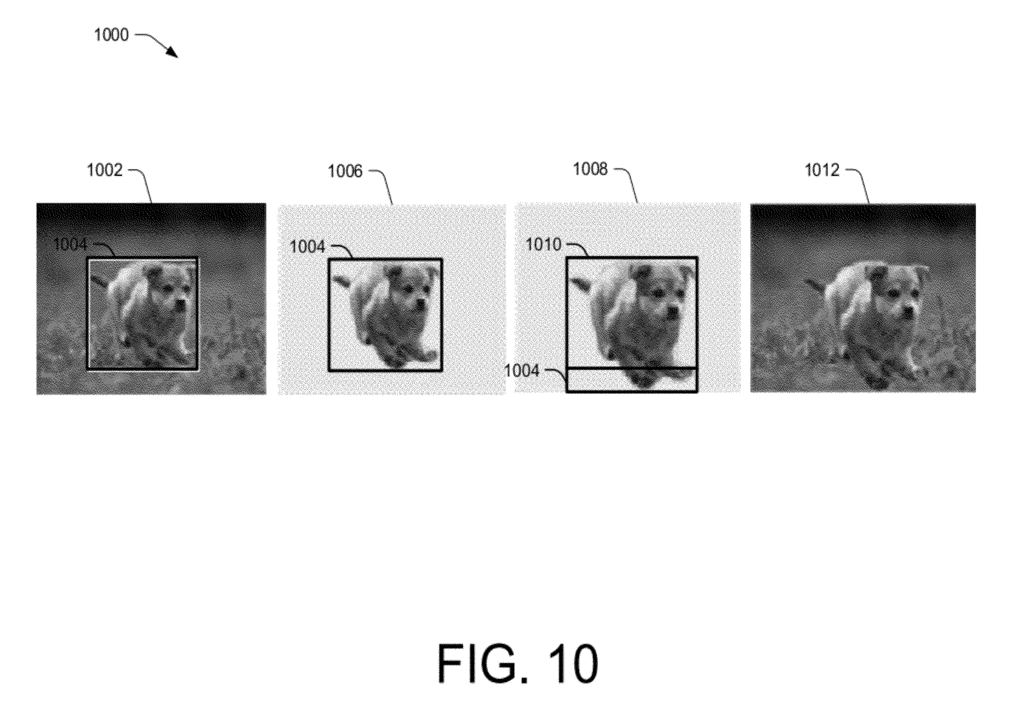

FIG. 10 shows a process 1000 for image region enlargement. Image 1002 is an original image that includes a selected image region 1004 having a boundary box as selected by a user. Image 1006 shows the selected image region 1004. Image 1008 shows enlargement of the selected image region 1004 from an original position 1010. Image 1012 shows the resulting composited image.

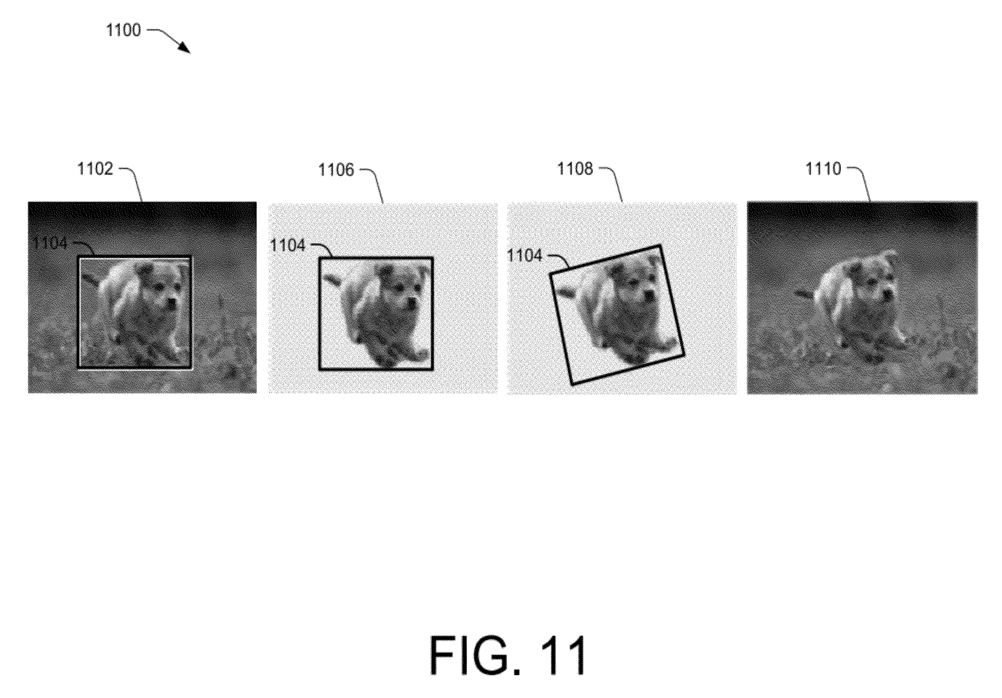

FIG. 11 shows a process 1100 for image region rotation. Image 1102 is an original image that includes a selected image region 1104 having a boundary box as selected by a user. Image 1106 shows the selected image region 1104. Image 1108 shows rotation of the selected image region 1104. Image 1110 shows the resulting composited image.

Therefore, a user is provided the ability to perform the following on a selected image region: 1) translation, where the selected image region is dragged and placed in another region of the image; 2) scaling, where the user drags an anchor point of the selected image region to resize the selected image region and keeping aspect ratio or changing the aspect ratio of the selected image region; 3) rotation, where the selected image region is rotated about an axis; 4) deletion, where the selected image region is removed. In addition, in certain cases, the selected region image may be re-colored. Furthermore, as described below, for certain implementations other actions may also be performed on the selected region image and the image.

Following the user operation, the pixels in the region image may be accordingly and automatically transformed without the user's intervention. Such a transformation can be obtained by using known bilinear interpolation techniques, or elated image transformation tools, such as Microsoft Corporation's GDIplus® graphics library. For example, the alpha channel values as discussed above for pixels, of the selected image can also be transformed by viewing the alpha channel as an image and transforming the alpha channel using tools in Microsoft Corporation's GDIplus® graphics library.

After the selected image region is transformed, image region placement is performed automatically without user intervention. Region placement can include a process of composing the transformed region image and the completed image. In certain cases, regarding image composition, if there is overlap with selected image regions, well known techniques and methods that apply rendering with coherence matting can be used to address placement. Furthermore, known re-coloring techniques can be applied as well to the transformed region image and the completed or composited image.

### Other Actions Performed on Image and Region Image

In order to further provide a satisfactory composited image, additional actions can be performed on the image and the selected region image. Such actions can be performed with and without user intervention. In certain implementations, the additional actions are performed at the option of the user.

### Hole Filling

In the concept of hole filling, a particular area or region of an image is filled. The area or region can be the selected region image or foreground as discussed above. For hole filling, several known techniques and methods, including hole filling algorithms can be used. An example region filling algorithm is described.

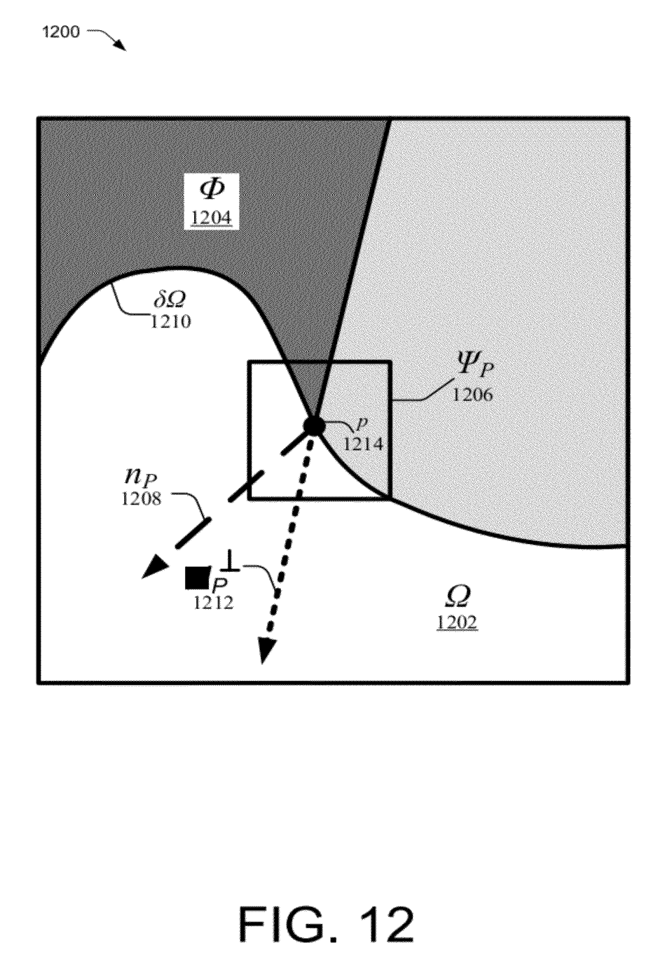

FIG. 12 shows an example notation diagram of an image 1200 for the region filling algorithm. The variable Ω 1202 represents a user selected target region to be removed and filled. A source region Φ 1204 can be defined as the entire image 1200 minus the target region Ω 1202, where I represents image 1200 (Φ=I−Ω). The source region Φ 1204 can be a dilated band around the target region Ω 1202, or can be manually specified by the user.

Given the patch Ψ_{P} 1206, the vector n_{P} 1208 is the normal to the contour δΩ 1210 of the target region Ω 1202. ∇Iₚ^{⊥} 1212 defines the isophote, or direction and intensity at a point p 1214.

A template window or patch can be represented by Ψ (e.g., Ψ_{P} 1206), and the size of the patch can be specified. For example, a default window size may be 9×9 pixels; however, the user may set the window size to a slightly larger size than the largest distinguishable texture element in the source region Φ 1204.

Each pixel can maintain a color value, or can be defined as “empty”, if the pixel is unfilled. Each pixel can have a confidence value, which reflects confidence in the pixel value, and which can be frozen once a pixel is filled. Patches along a fill front can also be given a temporary priority value, which determines the order in which the patches are filled. The following three processes are performed until all pixels have been filled:

Process (1): Computing patch priorities. Different filling orders may be implemented, including the “onion peel” method, where the target region is synthesized from the outside inward, in concentric layers.

In this example, a best-first filling algorithm is implemented, that depends on the priority values that are assigned to each patch on the fill front. The priority computation is biased toward those patches which are on the continuation of strong edges and which are surrounded by high-confidence pixels.

Patch Ψ_{P} 1206 is centered at the point p 1214 for some p ∈ δΩ, the priority or P(p) is defined as the product of two terms as described in the following equation.

P(p)=C(p)D(p) (16)

C(p) is the confidence term and D(p) is the data term, and are defined as follows:

$$\begin{matrix}C ( p ) = \frac{{\sum }_{q ∈ {Ψ}_{p} ⋂ \overline{Ω}} C ( q )}{\vert {Ψ}_{p} \vert} & ( 17 ) \\ D ( p ) = \frac{\vert ∇ {I}_{p}^{⊥} {n}_{p} \vert}{α} & ( 18 )\end{matrix}$$

where |Ψₚ| is the area of Ψ_{P} 1206, α is a normalization factor (e.g., α=255 for a typical grey-level image), and n_{P} 1208 is a unit vector orthogonal to the fill front or front contour δΩ 1210 in the point p 1214. The priority is computed for border patches, with distinct patches for each pixel on the boundary of the target region.

During initialization, the function C(p) is set to C (p)=0 ∀p ∈ Ω, and C(p)=1∀p ∈ τ−Ω.

The confidence term C(p) can be considered as a measure of the amount of reliable information surrounding the pixel (point) or p 1214. The intention is to fill first those patches (e.g., Ψ_{P} 1206) which have more of their pixels already filled, with additional preference given to pixels that were filled early on, or that were never part of the target region Ω 1202.

This can automatically incorporate preference towards certain shapes along the fill front δΩ 1210. For example, patches that include corners and thin tendrils of the target region Ω 1202 will tend to be filled first, as they are surrounded by more pixels from the original image. These patches can provide more reliable information against which to match. Conversely, patches at the tip of “peninsulas” of filled pixels jutting into the target region Ω 1202 will tend to be set aside until more of the surrounding pixels are filled in.

At a coarse level, the term C(p) of (1) approximately enforces the desirable concentric fill order. As filling proceeds, pixels in the outer layers of the target region Ω 1202 will tend to be characterized by greater confidence values, and therefore be filled earlier; pixels in the centre of the target region Ω 1202 will have lesser confidence values.

The data term D(p) is a function of the strength of isophotes (e.g., ∇Iₚ^{⊥} 1212), hitting the fill front δΩ 1210 at each iteration. This term D(p) boosts the priority of a patch that an isophote “flows” into. This encourages linear structures to be synthesized first, and, therefore propagated securely into the target region Ω 1202.

The data term data term D(p) tends to push isophotes (e.g., ∇Iₚ^{⊥} 1212) rapidly inward, while the confidence term C(p) tends to suppress precisely this sort of incursion into the target region Ω 1202.

Since the fill order of the target region Ω 1202 is dictated solely by the priority function P(p, it may be possible to avoid having to predefine an arbitrary fill order as performed in patch-based approaches. The described fill order is function of image properties, resulting in an organic synthesis process that can eliminate the risk of “broken-structure” artifacts and also reduces blocky artifacts without a patch-cutting step or a blur-inducing blending step.

Process (2): Propagating texture and structure information. Once priorities on the fill front δΩ 1210 have been computed, the patch Ψ_{P} 1206 with highest priority is found. The patch Ψ_{P} 1206 is filled with data extracted from the source region source region Φ 1204.

In traditional inpainting techniques, pixel-value information is propagated via diffusion; however, diffusion can necessarily lead to image smoothing, which results in blurry fill-in, especially of large regions.

Therefore, image texture can be propagated by direct sampling of the source region Φ 1204. A search is performed in the source region Φ 1204 for the patch which is most similar to patch Ψ_{P} 1206 as defined by the following equation:

$${Ψ}_{\hat{q}} = arg {min}_{{Ψ}_{q} ∈ Φ} d ( {Ψ}_{\hat{p}} , {Ψ}_{q} ) \qquad ( 19 )$$

where the distance d(Ψₐ, Ψ_{b}) between two generic patches Ψₐ and Ψ_{b} is defined as the sum of squared differences (SSD) of the already filled pixels in the two patches. Having found the source Ψ_{\hat{q}} the value of each pixel-to-be-filled, p′|p′ ∈ Ψ_{\hat{p}∩Ω}, is copied from its corresponding position inside Ψ_{\hat{q}}.

Therefore, it is possible to achieve the propagation of both structure and texture information from the source region Φ 1204 to the target region target region Ω 1202, one patch at a time.

Process (3): Updating confidence values. After the patch Ψ_{\hat{p}} has been filled with new pixel values, the confidence term C(p) is updated in the area delimited by Ψ_{\hat{p}} as follows:

C(q)=C(\hat{p})∀q∈ Ψ_{\hat{p}}∩Ω (20)

This update allows the ability to measure the relative confidence of patches on the fill front δΩ 1210, without image specific parameters. As filling proceeds, confidence values decay, indicating less confidence as to color values of pixels near the center of the target region Ω 1202.

### Text Query Submission

Text query submission can be optional user chosen process, which can be invoked if the user is desires particular content to fill a region. This process can include dynamically constructing a database of content. In general, for the text query submission, a user can type in a text query for a particular content, such as “grass”, to indicate the content of the region to be filled in. Relevant images or content can be returned from sources, such as the Internet, using for example image search engines.

The text query submission process can be supported by several known methods and techniques. Alternative queries can also involve non text queries. Similar images and content can be grouped with one another. Therefore, a query, such a text query can return multiple images or content. The user can choose from the returned images and content. The query can also implement semantic scene matching and other criteria that find “best fit” images and content. For example, certain images and content, may be irrelevant in the context of particular images, or may be too small (i.e., low resolution) or too large (i.e., high resolution) for the image. The text queries (queries) can be pixel based. In other words to assure that the size of the returned images and content is acceptable, the search can be performed for content and images have a certain pixel size that can fill the desired region of the image. This pixel based search further can support texture, gradient, and other color or intensity properties of the image.

### Example System

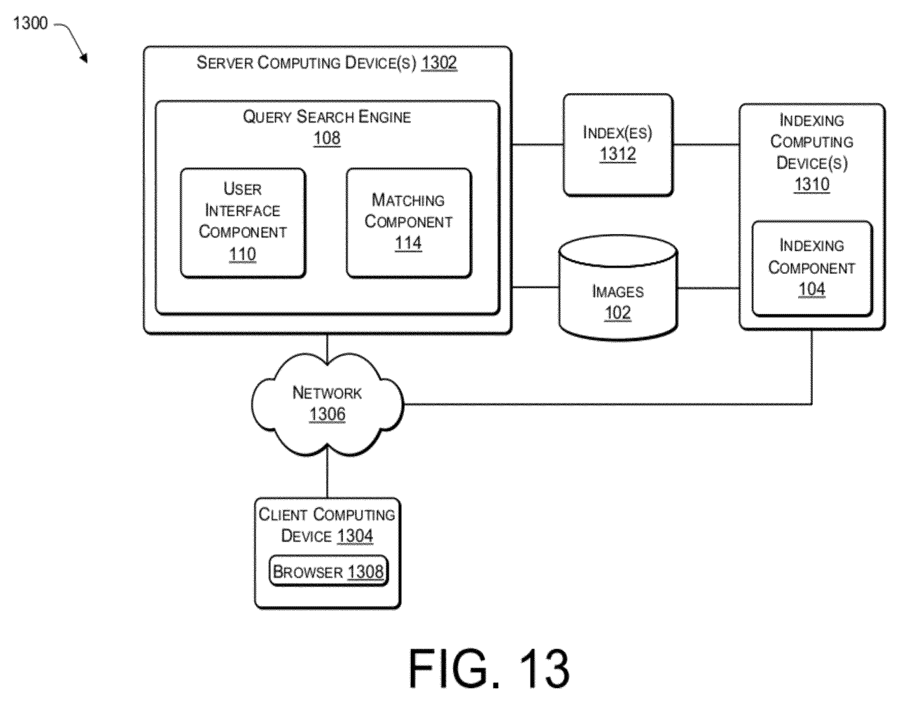

FIG. 13 illustrates an example of a system 1300 for carrying out region-based image manipulation according to some implementations herein. To this end, the system 1300 includes one or more server computing device(s) 1302 in communication with a plurality of client or user computing devices 1304 through a network 1306 or other communication link. In some implementations, server computing device 1302 exists as a part of a data center, server farm, or the like, and is able to serve as a component for providing a commercial search website. The system 1300 can include any number of the server computing devices 1302 in communication with any number of client computing devices 1304. For example, in one implementation, network 1306 includes the World Wide Web implemented on the Internet, including numerous databases, servers, personal computers (PCs), workstations, terminals, mobile devices and other computing devices spread throughout the world and able to communicate with one another. Alternatively, in another possible implementation, the network 1306 can include just a single server computing device 1302 in communication with one or more client devices 1304 via a LAN (local area network) or a WAN (wide area network). Thus, the client computing devices 1304 can be coupled to the server computing device 1302 in various combinations through a wired and/or wireless network 1306, including a LAN, WAN, or any other networking technology, using one or more protocols, for example, a transmission control protocol running over Internet protocol (TCP/IP), or other suitable protocols.

In some implementations, client computing devices 1304 are personal computers, workstations, terminals, mobile computing devices, PDAs (personal digital assistants), cell phones, smart phones, laptops, tablet computing devices, or other computing devices having data processing capability. Furthermore, client computing devices 1304 may include a browser 1308 for communicating with server computing device 1302, such as for presenting the user interface herein to a user and for submitting a search query to the server computing device 1302. Browser 1308 may be any suitable type of web browser such as Internet Explorer®, Firefox®, Chrome®, Safari®, or other type of software configured to enable submission of a sketch-based query for a search as disclosed herein.

In addition, server computing device 1302 may include query search engine 108 for responding to queries, such as text queries, received from client computing devices 1304. Accordingly, in some implementations, query search engine 108 may include user interface component 110 and matching component 114, as described above, for receiving queries, such as text queries. In some implementations, user interface component 110 may provide the user interface described herein as a webpage able to be viewed and interacted with by the client computing devices 1304 through browsers 1308.

Additionally, one or more indexing computing devices 1310 having indexing component 104 may be provided. In some implementations, indexing computing device 1310 may be the same computing device as server computing device 1302; however, in other implementations, indexing computing device(s) 1310 may be part of an offline web crawling search facility that indexes images available on the Internet. Thus, in some implementations images 102 are stored multiple websites on the Internet. In other implementations, images 106 are stored in a database accessible by server computing device 1302 and/or indexing computing device 1310. As discussed above, indexing component 104 generates one or more indexes 1312 for the images 102, such as the image index 106 for query search of the images 102 for image region filling.

Furthermore, while an example system architecture is illustrated in FIG. 13, other suitable architectures may also be used, and that implementations herein are not limited to any particular architecture. For example, in some implementations, indexing component 104 may be located at server computing device 1302, and indexing computing device 1310 may be eliminated. Other variations will also be apparent to those of skill in the art in light of the disclosure herein.

### Example Server Computing Device

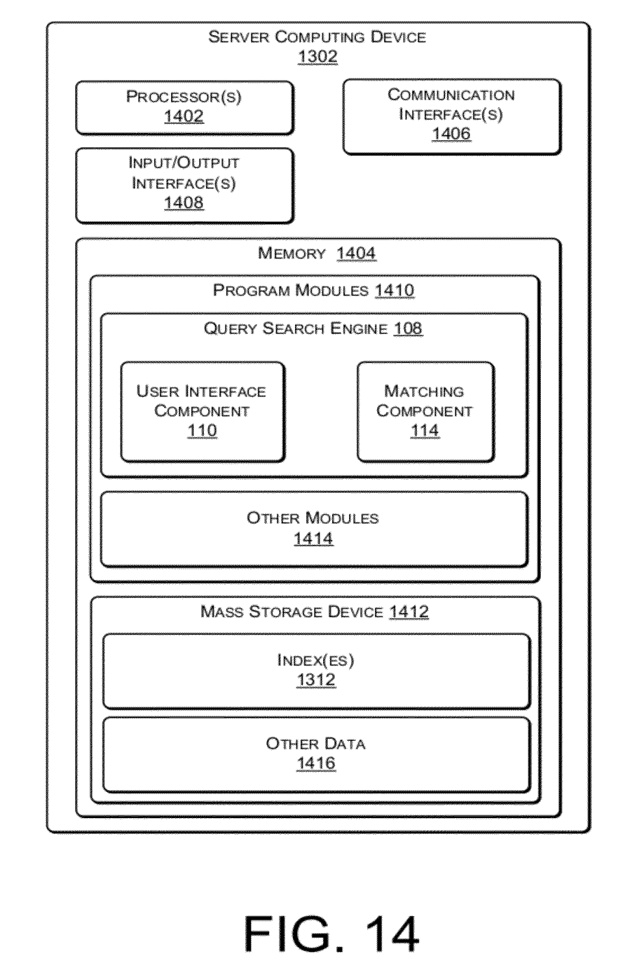

FIG. 14 illustrates an example configuration of a suitable computing system environment for server computing device 1302 and/or indexing computing device 1310 according to some implementations herein. Thus, while the server computing device 1302 is illustrated, the indexing computing device 1310 may be similarly configured. Server computing device 1302 may include at least one processor 1302, a memory 1304, communication interfaces 1406 and input/output interfaces 1408.

The processor 1402 may be a single processing unit or a number of processing units, all of which may include single or multiple computing units or multiple cores. The processor 1402 can be implemented as one or more microprocessors, microcomputers, microcontrollers, digital signal processors, central processing units, state machines, logic circuitries, and/or any devices that manipulate signals based on operational instructions. Among other capabilities, the processor 1402 can be configured to fetch and execute computer-readable instructions or processor-accessible instructions stored in the memory 1404, mass storage device 1412, or other computer-readable storage media.

Memory 1404 is an example of computer-readable storage media for storing instructions which are executed by the processor 1402 to perform the various functions described above. For example, memory 1404 may generally include both volatile memory and non-volatile memory (e.g., RAM, ROM, or the like). Further, memory 1404 may also include mass storage devices, such as hard disk drives, solid-state drives, removable media, including external and removable drives, memory cards, Flash memory, floppy disks, optical disks (e.g., CD, DVD), storage arrays, storage area networks, network attached storage, or the like, or any combination thereof Memory 1404 is capable of storing computer-readable, processor-executable program instructions as computer program code that can be executed on the processor(s) 1402 as a particular machine configured for carrying out the operations and functions described in the implementations herein.

Memory 1404 may include program modules 1410 and mass storage device 1412. Program modules 1410 may include the query search engine 108 and other modules 1414, such as an operating system, drivers, and the like. As described above, the query search engine 108 may include the user interface component 110 and the matching component 114, which can be executed on the processor(s) 1402 for implementing the functions described herein. In some implementations, memory 1404 may also include the indexing component 104 for carrying out the indexing functions herein, but in other implementations, indexing component 104 is executed on a separate indexing computing device. Additionally, mass storage device 1412 may include the index(es) 1312. Mass storage device 1412 may also include other data 1416 for use in server operations, such as data for providing a search website, and so forth.

The server computing device 1402 can also include one or more communication interfaces 1406 for exchanging data with other devices, such as via a network, direct connection, or the like, as discussed above. The communication interfaces 1806 can facilitate communications within a wide variety of networks and protocol types, including wired networks (e.g., LAN, cable, etc.) and wireless networks (e.g., WLAN, cellular, satellite, etc.), the Internet and the like.

### Example Client Computing Device

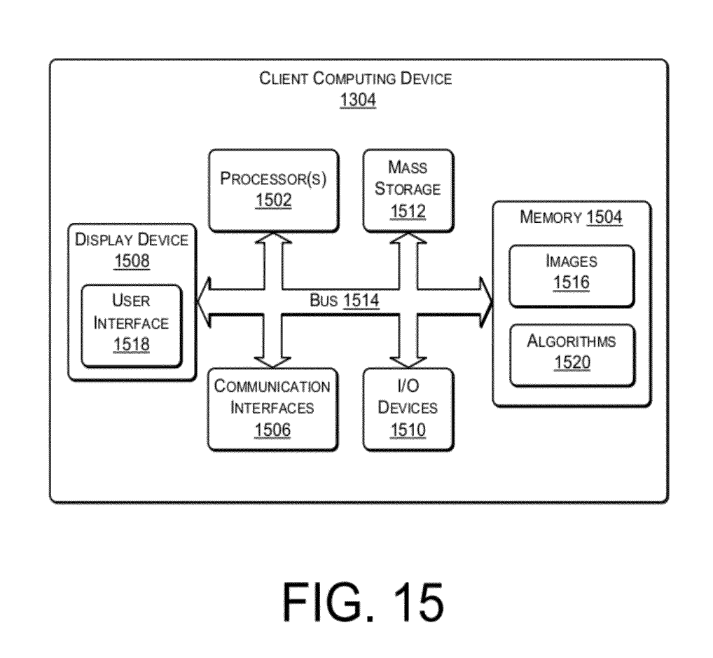

FIG. 15 illustrates an example configuration of a suitable computing system environment for client computing device 1304 according to some implementations herein. The client computing device 1304 may include at least one processor(s) 1502, a memory 1504, communication interfaces 1506, a display device 1508, input/output (I/O) devices 1510, and one or more mass storage devices 1512, all able to communicate through a system bus 1514 or other suitable connection.

The processor(s) 1502 may be a single processing unit or a number of processing units, all of which may include single or multiple computing units or multiple cores. The processor(s) 1502 can be implemented as one or more microprocessors, microcomputers, microcontrollers, digital signal processors, central processing units, state machines, logic circuitries, and/or any devices that manipulate signals based on operational instructions. Among other capabilities, the processor(s) 1502 can be configured to fetch and execute computer-readable instructions or processor-accessible instructions stored in the memory 1504, mass storage devices 1512, or other computer-readable storage media.

Memory 1504 and mass storage device 1512 are examples of computer-readable storage media for storing instructions which are executed by the processor 1502 to perform the various functions described above. For example, memory 1504 may generally include both volatile memory and non-volatile memory (e.g., RAM, ROM, or the like). Further, mass storage device 1512 may generally include hard disk drives, solid-state drives, removable media, including external and removable drives, memory cards, Flash memory, floppy disks, optical disks (e.g., CD, DVD), storage arrays, storage area networks, network attached storage, or the like, or any combination thereof Both memory 1504 and mass storage device 1512 may be collectively referred to as memory or computer-readable storage media herein. Memory 1504 is capable of storing computer-readable, processor-executable program instructions as computer program code that can be executed on the processor 1502 as a particular machine configured for carrying out the operations and functions described in the implementations herein. Memory 1504 may include images 1516 from which one or images are selected and manipulated using the described techniques and methods for region-based image manipulation. For example, the images 106 can be manipulated by through a user interface 1518 that is provided through display device 1508. In addition I/O devices 1510 provide the user the ability to select, deselect, and manipulate regions and objects of images 106 as described above. Furthermore, memory 1504 can also include algorithms 1520 that are used in region image manipulation.

The client computing device 1304 can also include one or more communication interfaces 1506 for exchanging data with other devices, such as via a network, direct connection, or the like, as discussed above. The communication interfaces 1506 can facilitate communications within a wide variety of networks and protocol types, including wired networks (e.g., LAN, cable, etc.) and wireless networks (e.g., WLAN, cellular, satellite, etc.), the Internet and the like.

The display device 1508, such as a monitor, display, or touch screen, may be included in some implementations for displaying the user interface 1518 and/or an image to a user. I/O devices 1510 may include devices that receive various inputs from a user and provide various outputs to the user, such as a keyboard, remote controller, a mouse, a camera, audio devices, and so forth. In the case in which display device 1508 is a touch screen, the display device 1508 can act as input device for submitting queries, as well as an output device for displaying results.

The example environments, systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or applications, and may be implemented in general purpose and special-purpose computing systems, or other devices having processing capability.

Additionally, the components, frameworks and processes herein can be employed in many different environments and situations. Generally, any of the functions described with reference to the figures can be implemented using software, hardware (e.g., fixed logic circuitry) or a combination of these implementations. The term “engine,” “mechanism” or “component” as used herein generally represents software, hardware, or a combination of software and hardware that can be configured to implement prescribed functions. For instance, in the case of a software implementation, the term “engine,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices or media. Thus, the processes, components and modules described herein may be implemented by a computer program product.

Although illustrated in FIG. 15 as being stored in memory 1504 of client computing device 1304, algorithms 1520, or portions thereof, may be implemented using any form of computer-readable media that is accessible by client computing device 1304. Computer-readable media may include, for example, computer storage media and communications media. Computer storage media is configured to store data on a non-transitory tangible medium, while communications media is not.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

In contrast, communication media may embody computer readable instructions, data structures, program modules, or other data in a modulated data signal, such as a carrier wave, or other transport mechanism.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### Example Search Process

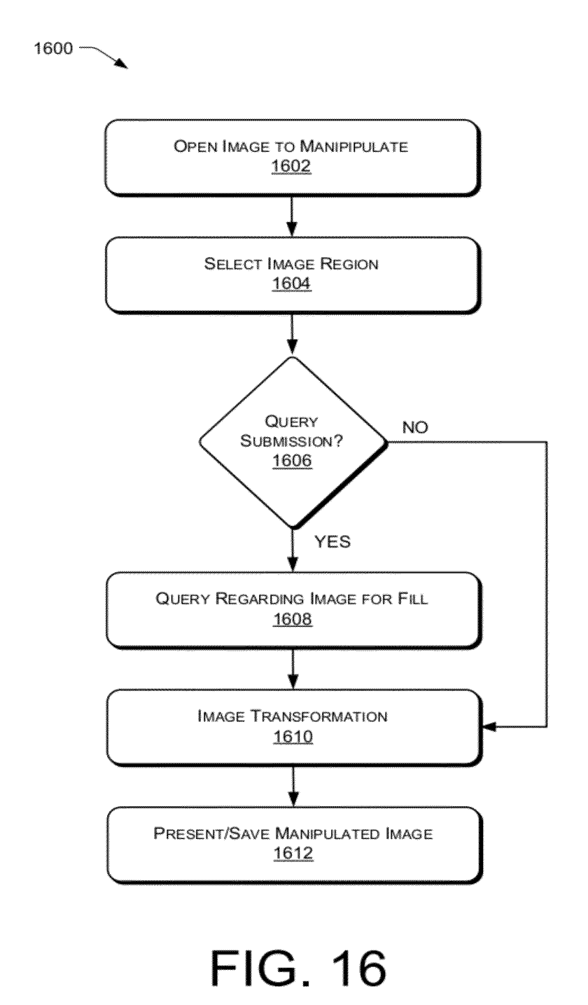

FIG. 16 depicts a flow diagram of an example of a region-based image manipulation process according to some implementations herein. In the flow diagram, the operations are summarized in individual blocks. The operations may be performed in hardware, or as processor-executable instructions (software or firmware) that may be executed by one or more processors. Further, the process 1600 may, but need not necessarily, be implemented using the system of FIG. 13, and the processes described above.

At block 1602, an image to be manipulated is selected and opened. The image can be selected from one of multiple sources, including local memory, the Internet, network databases, etc. The image can be opened using a various applications, such as browser or editing tool. An interface can be provided to open the image.

At block 1602, particular regions of the image are selected. A user can draw a few strokes over the particular regions, including regions of an object of interest, and regions indicating background and the like. The strokes can be distinguished by color or shade. Algorithms, as described above, such as augmented tree structures, can be used to represent and delineate the selected regions of the image. Refinement can be performed as to boundary of the regions. In addition, hole filling of the regions can be performed.

If the user desires to perform, a query such as text query for images and content to fill a region of the image, following the YES branch of block 1606, at block 1608, a query submission can be performed. For a text query, the user can type in words indicating the desired images or content to be used for fill. Relevant images and content can be from various sources, including databases and the Internet. The relevant images that are returned can be filtered as to applicability to the texture and other qualities of the image.

If the user does not desires not to conduct a query submission, following the NO branch of block 1606, and following block 1608, at block 1610 image transformation is performed. Image transformation can include selecting and bounding the region of interest, and particular objects of the image. Image transformation processes can include image region translation which moves the object within the image, image region enlargement which enlarges the image region object (in certain cases, the image region or object is reduced), image region rotation which rotates the image region or object, and deletion which removes the image region or object. In addition re-coloration can be performed on the final or composited image.

At block 1612, the final or composited image can be presented to the user, and/or saved. The saved composited image can be dynamically added to a database, and provided a tag, such as a text tag.

Accordingly, implementations herein provide for region-based image manipulation with minimal user intervention and input. The region-based image manipulation system herein enables users to select regions with a few brushstrokes and manipulate the regions using certain actions. Furthermore, implementations herein provide hole filling and searching of images and content to fill in regions of the image. Experimental results on different image manipulation have shown the effectiveness and efficiency of the proposed framework.

### CONCLUSION

Implementations herein provide a region-based image manipulation framework with minimal user intervention. Further, some implementations filling in particular selected region, including a query search, such as a text query search, of content and images. Additionally, some implementations provide refining images.

Although the subject matter has been described in language specific to structural features and/or methodological acts, the subject matter defined in the appended claims is not limited to the specific features or acts described above. Rather, the specific features and acts described above are disclosed as example forms of implementing the claims This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A system comprising:
a processor in communication with computer-readable storage media;
an algorithm maintained in the computer-readable storage media, the algorithm providing a user interface, and performing:
opening an image;
selecting with the user interface, one or more regions of the image using brushstrokes specific to each of the one or more regions; and
transforming, with the user interface, one of the one or more regions.

2. The system of claim 1, wherein the image is from an indexed database.

3. The system of claim 1, wherein the selecting is performed based on pixels of the one or more regions, the pixels associated with the brushstrokes.

4. The system of claim 1, wherein the selecting is performed using image segmentation that creates spanning trees of graphs representing the one or more regions.

5. The system of claim 4, wherein superpixels are used to create the graphs before the spanning trees are created.

6. The system of claim 1, wherein the selecting includes refining the boundaries of the one or more regions.

7. The system of claim 1, wherein the transforming includes bounding one of the one or more regions.

8. The system of claim 1, wherein the transforming is one of the following: translating, enlarging, rotating, or deleting.

9. The system of claim 1, wherein the algorithm further performs filling of one of the one or more regions.

10. The system of claim 1, wherein the algorithm further performs a text query search for objects to fill one of the one or more regions.

11. A method performed by a computing device comprising:
opening an image to be manipulated based on regions of the image;
identifying one or more regions of the image by strokes applied over the one or more regions;
segmenting the one or more identified regions;
transforming one of the one or more identified regions; and
creating a composited image.

12. The method of claim 11, wherein opening the image is from one of local memory, the Internet, or networked database.

13. The method of claim 11, wherein the identifying includes associating the strokes with pixels of the one or more regions.

14. The method of claim 11, wherein the segmenting includes creating an augmented tree structure that represents graphs of the image.

15. The method of claim 11, wherein the segmenting includes creating a bit map image of the identified regions, each pixel of the identified region identified by four channels R, G, B and A.

16. The method of claim 11, transforming bounds the one of the one or more identified regions, and performs one of the following: translation, enlargement, rotation, or deletion.

17. The method of claim 11, wherein the creating includes image region boundary refinement.

18. The method of claim 11 further comprising filling in one or more of the identified images.

19. A method performed by a computing device comprising:
opening an image of a number of images;
selecting regions of the image by applying generalized brushstrokes over pixels of the regions;
transforming one of the regions of the image; and
filling in the one of the regions, or another region of the image.

20. The method of claim 20 further comprising performing a text query search for images to perform he filling.
